(19) United States
(12) Patent Application Publication
(10) Pub. No.: US 2012/0175353 A1
(43) Pub. Date: Jul. 12, 2012

(54) WELDING SYSTEM AND WELDING METHOD

(76) Inventors: Andreas Josef Birnesser, Rheinmuenster (DE); Reiner Ramsayer, Schwieberdingen (DE)

(21) Appl. No.: 13/140,388

(22) PCT Filed: Oct. 20, 2009
(86) PCT No.: PCT/EP2009/063739

§ 371 Date: Mar. 26, 2012

(30) Foreign Application Priority Data
Dec. 17, 2008 (DE) 10 2008 054 798.0

(51) Int. Cl. B23K 26/03

(52) U.S. Cl. 219/121.63

(57) ABSTRACT

A welding system is described as having an energy source, in particular a laser beam source, for implementing a heat transfer for welding a first component to at least one second component in a connection area and having a sensor for detecting the processing radiation of the welding procedure. The sensor includes a measuring probe. Also described is a welding method.

### FIELD OF THE INVENTION

The present invention relates to a welding system for welding at least two components and a welding method.

### BACKGROUND INFORMATION

In the case of laser welding, in particular of automobile and automotive supplier components, the reproducible manufacturing of the seam parameters, for example, the welding depth, the seam area, the seam width, etc., is often only possible in a small processing window. These problems occur in particular in the case of the laser welding of thin sleeves or in the case of joining of thick components on thin components, i.e., when a thicker joint partner is to be welded into a thinner joint partner without welding through the thinner joint partner.

A method is discussed in German patent document DE 10 2004 050 164 A1 in which, using a sensor (pyrometer), the processing radiation, which correlates with the processing temperature, on the component rear side is used as a control variable to regulate the laser beam output. It is presumed in this case that the processing radiation on the component rear side (temperature radiation) correlates with the welding depth and a feedback control circuit may be established. However, the known method may fundamentally only be applied where the component rear side of the welding procedure is accessible by currently common optical sensors. In contrast, the method is not applicable in depressions, thin sleeves, etc., because of the restricted accessibility for conventional sensors.

### SUMMARY OF THE INVENTION

The exemplary embodiments and/or exemplary methods of the present invention is therefore based on an object of a welding system, using which the processing radiation of the welding procedure is also readily detectable in depressions, thin sleeves, peripherally closed components, etc., in particular to be able to regulate the output of the energy source to implement the heat transfer. Furthermore, the object is to specify a correspondingly optimized welding method.

This object is achieved with respect to the welding system by the features described herein and with respect to the welding method by the features described herein. Advantageous refinements of the present invention are specified in the subclaims. All combinations of at least two of the features disclosed in the description, the claims, and/or the figures are within the scope of the present invention. To avoid repetitions, features disclosed with respect to the device are to be considered as disclosed and claimable with respect to the method. Similarly, features disclosed with respect to the method are to be considered as disclosed and claimable with respect to the device.

The exemplary embodiments and/or exemplary methods of the present invention are based on the finding that, because of their dimensions, conventional sensors having a frontal optical sensor element are not suitable for being inserted into depressions, peripherally closed components such as sleeves, etc.—in particular not for measuring in the radial direction. In order to also allow problem-free temperature detection or detection of processing radiation of the welding procedure, which correlates with the temperature, which may be on the side facing away from the energy source, in the case of the above-mentioned components, the present invention proposes that the sensor, which may be configured as a pyrometer, includes a measuring probe or may be configured as a measuring probe. A measuring probe is to be understood as an elongated, in particular rod-shaped, which may be thin specific embodiment, i.e., having a small diameter, which allows the sensor to be at least sectionally inserted into depressions, peripherally closed components, etc., in order to thus detect the processing radiation, in particular the intensity thereof, on the internal side. It is particularly may be that if the energy source is located on the external side, it may be always at the same peripheral position of the components as the measuring probe. Furthermore, a specific embodiment of the welding system in which it is configured as a laser welding system may be used, i.e., the energy source is configured as a laser beam source. The welding system according to the present invention may be used both for manufacturing peripheral weld seams and also for spot welding.

In one specific embodiment of the welding system, the first and/or the second component is/are configured to be sleeve-shaped, which may be peripherally closed, so that the measuring probe for detecting the temperature of the welding procedure must be inserted into at least one of the two components along the longitudinal extension of the measuring probe to be able to detect the temperature of the welding procedure on the internal side of at least one of the two components, in particular on the internal periphery (internal lateral surface) of at least one of the two components or the component combination.

Furthermore, in one specific embodiment of the welding system the at least two components have a differing thickness extension, the component having the greater, in particular radial, thickness extension which may be situated outside the thinner component, so that the thinner component is heated through the thicker component from the external side using the energy source, in particular a laser beam source. It may be ensured with the aid of the sensor in the form of a measuring probe that the thinner component is not welded through during the welding procedure, in particular if the output of the energy source is controlled as a function of the processing radiation and thus as a function of the temperature of the welding procedure, as explained in greater detail hereafter. In other words, the processing radiation detected using the sensor may represent the control variable for regulating the energy output of the energy source, in particular the laser beam source.

To be able to detect a temperature of the welding procedure laterally in relation to the longitudinal extension of the measuring probe, i.e., from the radial direction, it is advantageously provided in a refinement of the present invention that a measuring axis (measuring direction) is situated at an angle to the longitudinal axis of the measuring probe. The measuring axis is the direct connection line between the so-called “hot spot,” i.e., the hottest point, and the measuring probe, which may be an optical sensor element of the measuring probe. Furthermore, the measuring axis may be positioned perpendicularly to the area extension of such a sensor. The measuring axis may be situated at an angle to the longitudinal axis of the measuring probe from an angle range between approximately 10° and approximately 170°, which may be between approximately 30° and approximately 150°, and which may be between approximately 50° and approximately 130°, very particularly may be between approximately 70° and approximately 110°. For most applications it is advantageous to situate the measuring axis at least approximately perpendicularly to the longitudinal extension of the measuring probe or to design the measuring probe in such a way that such a position of the measuring axis results in relation to the longitudinal axis of the measuring probe. Furthermore, the measuring axis may coincide at least approximately with the longitudinal axis of a laser beam of the energy source.

In a refinement of the exemplary embodiments and/or exemplary methods of the present invention, it is advantageously provided that the first and the second components are situated rotatably relative to the measuring probe and energy source. It is possible to rotate the first and the second components jointly relative to the stationary measuring probe and the stationary energy source. It is also possible to situate the two components fixed in place and to rotate the measuring probe jointly with the energy source. Furthermore, one specific embodiment is implementable in which all of the above-mentioned parts rotate, the measuring probe, or at least its detection area, which may be located at all times at the same peripheral position of the two components as the energy source or the laser beam emitted therefrom.

The sensor may include at least one sensor element, in particular a photodiode or a photodiode array, to detect the processing radiation and therefore the temperature of the welding area.

There are various possibilities with respect to the arrangement of the above-mentioned sensor element, in particular the at least one photodiode. The at least one sensor element may thus, for example, be situated directly on the measuring probe, which may be in a front area of the measuring probe, very particularly may be on a radiation absorption section of the measuring probe, i.e., on a section of the measuring probe which is situated adjacent to the connection area of the two components during operation of the welding system, and may therefore detect the thermal radiation directly, which may be without prior deflection. In case of such an arrangement of the at least one sensor element, the sensor signal may be transmitted wirelessly from the sensor element to an analysis unit which is spaced apart from the radiation absorption section. However, a transmission via a cable connection may be used, the cable connection being guided outward along a rod-shaped section of the measuring probe which adjoins the radiation absorption section of the measuring probe.

In an alternative specific embodiment, the sensor element is situated at a distance to the radiation absorption section of the measuring probe and a sensor signal is not transported along the rod section, but rather the processing radiation to be detected by the sensor element. The longitudinal extension of the rod section of the measuring probe may be greater than 5 cm, which may be greater than. 10 cm, particularly may be greater than 15 cm, and may be greater than 20 cm, in order to also be able to comfortably detect the temperature of the welding procedure in large component depths.

For the last-mentioned specific embodiment, at least one optical fiber (optical waveguide) is to be provided in and/or on the rod section to guide the radiation from the radiation absorption section up to the sensor element.

It is additionally or alternatively possible to design the rod section directly as an optical waveguide, for example, by designing the rod conductor as a glass rod. The glass rod may be designed as a hollow rod which is internally coated highly reflectively, in particular as a hollow cylinder, or as a solid material rod which is externally coated highly reflectively. The design of the measuring probe, at least the rod section, as a glass rod has the advantage that mechanical stabilization may be dispensed with, since the optical waveguide itself takes over the mechanical function of the measuring probe. The glass rod is to be adapted to the wavelength of the processing radiation to be detected and may be reflectively coated in such a way that light remains inside the glass rod. A lens surface may advantageously be ground onto the tip of the glass rod, i.e., in the area of the radiation absorption section, this lens surface preferably not being reflectively coated, in order to capture as much processing radiation as possible from the “hot spot” and bring it into the glass rod. The above-mentioned sensor and optionally at least one optical filter may be located on the end of the glass rod facing away from the radiation absorption section. It is advantageous in the case of a specific embodiment of the glass rod as a hollow rod that the radiation may propagate in air. Since glass always has a wavelength-dependent coefficient of absorption, this form of the measuring probe prevents specific wavelengths from being attenuated or blocked in their intensity. This is advantageous in particular if electromagnetic processing radiation in the UV range or the far IR range is to be observed, since glass is generally not transparent in this range.

In one specific embodiment, a radiation deflection unit, in particular a mirror, is provided in the radiation absorption section of the measuring probe, using which the detected radiation, in particular the laterally detected radiation, is deflectable at least approximately in the direction of the longitudinal extension of the measuring probe.

In one specific embodiment of the welding system, as indicated at the outset, the output of the energy source is controllable as a function of the processing radiation ascertained with the aid of the sensor and thus as a function of the temperature.

This regulation may be performed by the analysis unit, which may have a controlling effect on the energy source at the same time.

Furthermore, the exemplary embodiments and/or exemplary methods of the present invention also relates to a welding method. The method according to the present invention is characterized in that the sensor is designed in the form of a measuring probe, or includes a measuring probe, in order to also be able to detect the processing radiation of the welding procedure, in particular for regulatory purposes of the energy source output, in depressions or peripherally closed components on the internal side of the components.

Further advantages, features, and details of the exemplary embodiments and/or exemplary methods of the present invention result from the following description of the exemplary embodiments and on the basis of the drawings.

### BRIEF DESCRIPTION OF THE DRAWINGS

FIG. 1 shows a schematic view of a comparison of a conventional sensor according to the related art and a sensor having a measuring probe.

FIG. 2 shows an alternative welding system having a sensor designed as a measuring probe, in which a sensor signal is guided through a rod section.

FIG. 3 shows an alternative specific embodiment of a welding system having a sensor in the form of a measuring probe, the detected processing radiation being guided by an optical waveguide through the rod-shaped section of the measuring probe.

FIG. 4 shows a further alternative specific embodiment of a welding system having a sensor in the form of a measuring probe, whose measuring probe is itself designed as an optical waveguide, for example, as a reflectively coated solid material glass rod or as a reflectively coated metal hollow rod.

FIG. 5 shows a further alternative specific embodiment of a welding system having a radiation deflection unit on a radiation absorption section of the measuring probe.

### DETAILED DESCRIPTION

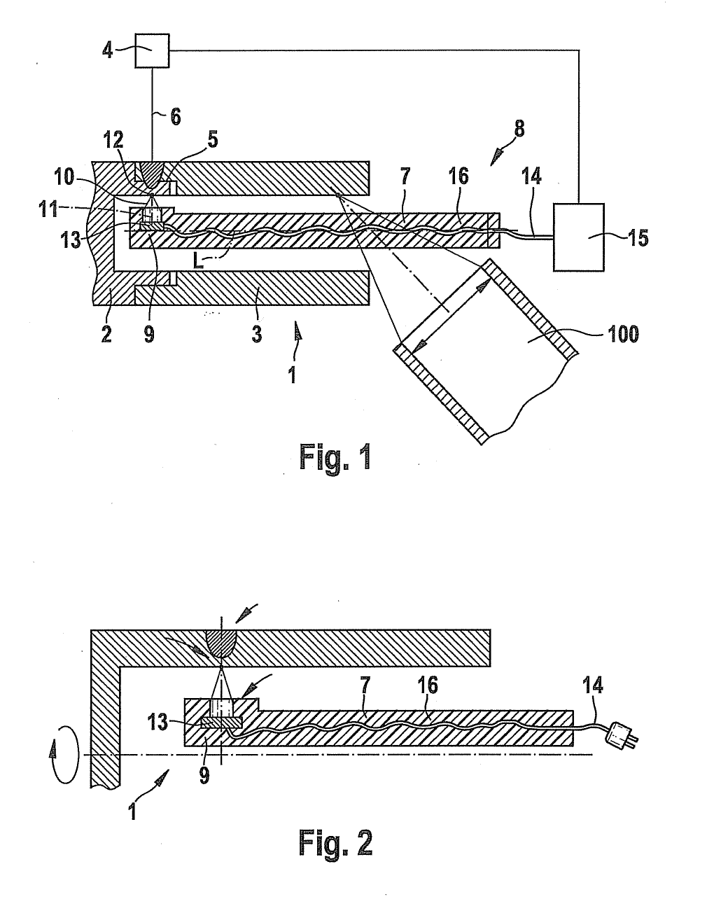

A welding system 1 is shown in FIG. 1. Welding system 1 includes a first lid-shaped component 2 and a second sleeve-shaped component 3, which are welded to one another with the aid of an energy source 4, a laser beam source here, in a connection area 5. The internal, thinner-walled component is melted through external component 3 in the welding area 5 with the aid of a laser beam 6. A sensor 8 including a measuring probe 7 is provided for monitoring the processing radiation, which correlates with the temperature of the welding procedure. Measuring probe 7 allows the processing radiation of the welding procedure to be detected on the internal periphery of component 2. Such a temperature detection would not be possible using a pyrometer 100 according to the related art, indicated on the right in the plane of the drawing, since it is not insertable into sleeve-shaped component 3 and may exclusively measure a temperature or absorb thermal radiation in the axial direction.

Measuring probe 7 includes, situated on the left in the plane of the drawing, a front radiation absorption section 9, which is struck directly by processing radiation 10 of the welding procedure. It is noteworthy that an (imaginary) measuring axis 11, here a direct connection line between a measuring spot 12 and a sensor element (photo sensor) 13, runs perpendicularly to the longitudinal extension, i.e., to longitudinal axis L of measuring probe 7. Sensor element 13, which is designed as a photodiode or a photodiode array, for example, is located in above-mentioned, front radiation absorption section 9 of measuring probe 7. Sensor 13 is connected via a cable connection 14 to an analysis unit 15, which is situated outside components 2, 3, to conduct signals. Cable connection 14 is guided through a rod-shaped section 16 (rod section) of measuring probe 7 in the axial direction for this purpose. Analysis unit 15 is simultaneously designed as a regulating unit and sets the output of energy source 4 as a function of the intensity of the detected processing radiation, which may be in such a way that internal component 2 is not welded through.

In the specific exemplary embodiment shown, energy source 4 and measuring probe 7 of sensor 8 are situated fixed in place, components 2, 3 being rotated around a component longitudinal axis. Measuring spot 12 is to be positioned at all times below the “hot spot” in order to allow exact regulation of the output of energy source 4. Alternatively, additionally or alternatively to a component rotation, it is possible to rotate measuring probe 7 and energy source 4 or alternatively only to rotate laser beam 6; in this case it must be ensured that laser beam 6 and measuring probe 7 move synchronously, so that measuring spot 12 of measuring axis 11 is located directly below the “hot spot” at all times.

The welding system according to FIG. 1 may have optical filters (not shown) if needed, via which the spectral range to be detected for the measurement may be selected. Additionally or alternatively, a corresponding optical system, for example, a lens or a lens structure may be implemented for focusing on the “hot spot” (hottest point under the welding point).

FIG. 2 shows a similarly constructed welding system 1, energy source 4 and analysis unit 15 not being shown for reasons of clarity. Sensor element 13, which is situated in front radiation absorption section 9 of measuring probe 7, may be recognized. A cable connection 14 for conducting electrical signals of sensor element 13 to analysis unit 15 is guided through rod-shaped section 16 of measuring probe 7.

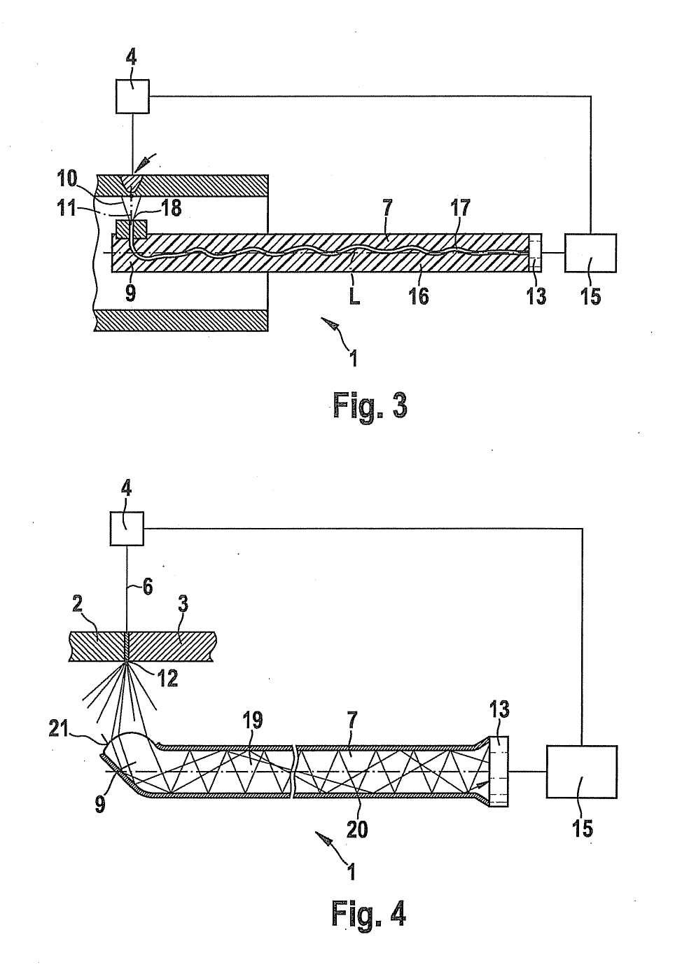

One further alternative specific embodiment of a welding system 1 is shown in FIG. 3. Measuring probe 7 is equipped here with an optical fiber 17, for example, a glass fiber. Frontal side 18 of optical fiber 17 is oriented parallel to longitudinal axis L of measuring probe 7, resulting in a perpendicular orientation of measuring axis 11 in relation to longitudinal axis L. In other words, optical fiber 17 is situated in such a way that radiation 10 may be absorbed from the radial direction in relation to longitudinal axis L of measuring probe 7.

Optical fiber 17 extends, starting from front radiation absorption section 9 of measuring probe 7, up to a sensor element 13, which is situated on the end of rod-shaped section 16 of measuring probe 7, and is connected to analysis unit 15 to conduct signals, similarly to FIG. 1. Optical fiber 17 collects the temperature radiation in accordance with its acceptance angle in the illustrated structure and conducts it inside optical fiber 17, optionally through a filter (not shown) to sensor element 13, for example, a photodiode. If needed, optical fiber 17 may have an optical structure (not shown), for example, at least one lens, in particular in the area of frontal side 18, whereby more exact focusing is possible. Additionally or alternatively, optical filters may be provided for selecting the spectral range, which may be already situated in radiation absorption section 9, more precisely in the area of frontal side 18 of optical fiber 17.

Furthermore, the optical filtering may already be performed inside optical fiber 17 through suitable doping or alteration of the optical properties of fiber 17.

FIG. 4 shows a further alternative exemplary embodiment of a welding system 1. Measuring probe 7 used therein is designed per se as an optical waveguide 19. In other words, optical waveguide 19 takes over the mechanical support or holding function of measuring probe 7. In the exemplary embodiment shown in FIG. 4, measuring probe 7 is a solid glass rod, which is adapted to the wavelength of the desired processing radiation to be detected. The glass rod is reflectively coated using a reflective coating 20, i.e., implemented as highly reflective, so that the light remains inside the glass rod. The section of measuring probe 7 forming radiation absorption section 9 has a ground lens surface 21 and is not reflectively coated, so that as much temperature radiation as possible is collected from measuring spot 12 and brought into the glass rod. A sensor element 13, for example, a photodiode, is situated on the end of measuring probe 7 or the glass rod facing away from radiation absorption section 9. Optical filters also provided there are not shown.

Alternatively, one specific embodiment is also implementable in which the glass rod is not made from solid material, but is rather configured as what may be a cylindrical hollow rod. In this case, the internal surface of the glass rod must be coated highly reflectively for the radiation to be observed. This embodiment has the advantage that the processing radiation may propagate in air. Since glass always has a wavelength-dependent coefficient of absorption, this form of measuring probe 7 prevents specific wavelengths from being attenuated or blocked in their intensity.

In one further alternative specific embodiment (not shown), instead of a glass cylinder, a metallic cylinder (hollow metal rod) may also be used, which fulfills a comparable function and is coated highly reflectively on the internal periphery.

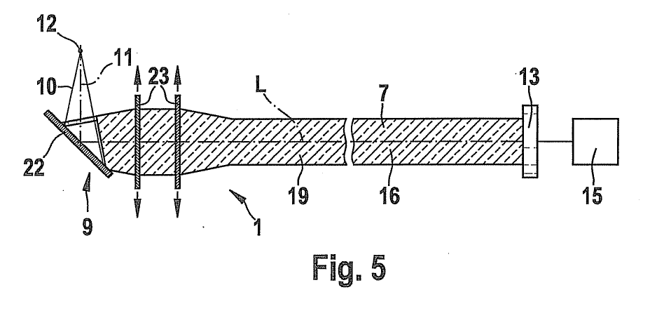

FIG. 5 schematically shows a further simplified view of a welding system 1. It includes an optical waveguide 19 and a radiation deflection unit 22, which is situated at the end on optical waveguide 19 in radiation absorption section 9, and which is in the form of a mirror here, which deflects processing radiation 10 emitted from measuring spot 12 into measuring probe 7. It is apparent that in the exemplary embodiment shown, measuring axis 11 is situated at an angle to longitudinal axis L of measuring probe 7, an angle of approximately 95° here.

As may also be inferred from FIG. 5, lenses 23 for focusing absorbed processing radiation 10 are provided directly adjoining radiation absorption section 9.

An optical sensor 13 for absorbing the processing radiation conducted through rod-shaped section 16 of measuring probe 7 is located at the end on measuring probe 7. As in the preceding exemplary embodiments, sensor element 13 is connected to an analysis unit 15 to conduct signals, which is simultaneously a regulating unit for regulating the output of the energy source (not shown in FIG. 5 for reasons of clarity).

1-15. (canceled)

16. A welding system, comprising:
an energy source for implementing a heat transfer for welding a first component to at least one second component in a connection area; and
a sensor for detecting a processing radiation of a welding procedure, wherein the sensor includes a measuring probe.

17. The welding system of claim 16, wherein at least one of the first component and the second component is configured as a sleeve-shaped, which is peripherally closed, and wherein the measuring probe is insertable into the at least one of the first component and the second component to detect the processing radiation of the welding procedure on the internal side, which is on the internal periphery of the first component and/or second component).

18. The welding system of claim 16, wherein a measuring axis is situated at an angle from an angle range between approximately 10° and approximately 170° to a longitudinal axis of the measuring probe.

19. The welding system of claim 16, wherein the first component and the second component are situated rotatably relative to the measuring probe and the energy source.

20. The welding system of claim 16, wherein the sensor includes a sensor element, which is a photodiode or a photodiode array, for detecting the processing radiation.

21. The welding system of claim 20, wherein the sensor element is situated in a radiation absorption section of the measuring probe, which is situated adjacent to the connection area, and the sensor signal is guided wirelessly or along a rod-shaped section of the measuring probe, with the aid of at least one cable, to an analysis unit, or the sensor element is situated at a distance to the radiation absorption section and the processing radiation is guided along the rod section to the analysis unit.

22. The welding system of claim 21, wherein at least one optical fiber is provided for guiding the processing radiation along the rod section.

23. The welding system of claim 21, wherein the rod section for guiding the processing radiation along the rod section is configured as an optical waveguide, which is particularly internally reflectively coated, and which is configured as a solid glass rod, or as a hollow rod, which is metallic or glass.

24. The welding system of claim 21, wherein a radiation deflection unit is situated in the radiation absorption section.

25. The welding system of claim 21, wherein the longitudinal extension of the rod section is greater than 5 cm.

26. The welding system of claim 16, wherein the output of the energy source is controllable as a function of the processing radiation, which is the processing radiation intensity ascertained with the aid of the sensor.

27. A welding method, wherein a heat input for welding a first component to at least one second component in a connection area is implemented using an energy source, and the processing radiation of the welding procedure is detected using a sensor, and wherein the sensor includes a measuring probe.

28. The welding method of claim 27, wherein at least one of the first component and the second component is configured as a sleeve-shaped, which is peripherally closed, and the measuring probe is inserted into at least one of the first component and the second component to detect the processing radiation intensity of the welding procedure on the internal side, which is on the internal periphery, of the at least one of the first component and the second component.

29. The welding method of claim 27, wherein the first component and the second component are rotated relative to the measuring probe and the energy source.

30. The welding method of claim 27, wherein the energy output of the energy source is controlled as a function of the processing radiation, which is the processing radiation intensity, ascertained with the aid of the sensor.

31. The welding system of claim 16, wherein a measuring axis is situated at an angle from an angle range between approximately 30° and approximately 150° to a longitudinal axis of the measuring probe.

32. The welding system of claim 16, wherein a measuring axis is situated at an angle from an angle range between approximately 50° and approximately 130° to a longitudinal axis of the measuring probe.

33. The welding system of claim 16, wherein a measuring axis is situated at an angle from an angle range between approximately 70° and approximately 110° to a longitudinal axis of the measuring probe.

34. The welding system of claim 21, wherein the longitudinal extension of the rod section greater than 10 cm.

35. The welding system of claim 21, wherein the longitudinal extension of the rod section greater than 15 cm.

36. The welding system of claim 21, wherein the longitudinal extension of the rod section greater than 20 cm.

37. The welding system of claim 16, wherein the energy source includes a laser beam source.
